(19) United States
(12) Patent Application Publication
(10) Pub. No.: US 2017/0068860 A1
(43) Pub. Date: Mar. 9, 2017

(54) SYSTEM FOR MEASURING CROWD DENSITY

(71) Applicant: Alex Adekola, Brookhaven, GA (US)

(72) Inventor: Alex Adekola, Brookhaven, GA (US)

(21) Appl. No.: 14/848,801

(22) Filed: Sep. 9, 2015

(51) Int. Cl. G06K 9/00; G06T 7/00

(52) U.S. Cl. CPC G06K 9/00778; G06T 7/0038; G06T 2207/30232; G06T 2207/30242; G06T 2207/10016

(57) ABSTRACT

A system for displaying overall venue crowd density as determined and interpreted by a user from audio and/or visual information crowd density sensor as well as other potential crowd sourced information gathered from a displayed on a users preferred device. A system for measuring crowd density data which allows businesses to create a means for marketing their venue, by allowing customers to quickly evaluate the crowd density at an establishment. It comprises a device present at an establishment where potential customers may rapidly evaluate which businesses have higher or lower crowd densities that may fit their mood. It allows non-intrusive, private means of recording crowds.

### CROSS-REFERENCE TO RELATED APPLICATIONS

Not applicable.

### STATEMENT REGARDING FEDERALLY SPONSORED RESEARCH AND DEVELOPMENT

Not applicable.

### REFERENCE TO SEQUENCE LISTING APPENDIX

Not applicable.

### BACKGROUND OF INVENTION

Field of the Invention/Technical Field

The disclosure herein relates to the technical discipline of business systems, and more definitively, the technological discipline of client server systems, and lastly, the technological field of video recording systems.

Related Art of the Invention

In general, people have attempted to establish a means to evaluate population density remotely. The U.S. Pat. No. 8,931,105 (U.S. Pat. No. 8,931,105) discloses a linked library of modules that communicate to a device. However, it does not contemplate, communication being primarily mediated by the device nor, does U.S. Pat. No. 8,931,105 disclose client server interactions. The U.S. Pat. No. 7,774,001 (U.S. Pat. No. 7,774,001) discloses a means to measure crowd density via a mobile communication device. However, it does not disclose a simplified means for measuring crowd density. Nor, does it disclose it a means to ameliorate privacy concerns related to the gathering of crowdedness data. Nor, does it disclose fixed cameras at a place wherein said data can be perpetually accessed and is not dependent on mobile device presence. The US patent publication 20120278904 (20120278904) discloses a means for distributing audiovisual content to a user. However, it does not disclose a means for measuring crowdedness. Nor, does it disclose client server interactions for evaluation of audiovisual crowdedness content. Nor, does it disclose non-licensing based content meant to be quickly evaluated by interested parties for evaluating crowdedness data.

### GENERAL SUMMARY OF THE INVENTION

In general, the system for measuring crowd density data solves numerous problems as highlighted in the background. For example, it allows businesses to create a means for marketing their venue, by allowing customers to quickly evaluate the crowd density at an establishment. Further, it comprises a device that is cheap, easy to install, and is defined by ifs clear functionality, which reflects its simplicity to use and low cost. Further, customers may rapidly evaluate which businesses have higher or lower crowd densities that may fit their emotional or financial criteria. In addition, the device settings allow non-intrusive, private means of recording crowd density by making video loops at specified times, such that behavior of individual customers is hard to determine and track.

It is an object of the system for measuring crowd density data to allow a business to advertise different portions of their establishment. Yet another object of the system for measuring crowd density data is to allow a business to cheaply advertise. Yet another object of the system for measuring crowd density data is to allow a business to benefit off of a positive feedback loop of crowdedness. Yet another object of the system for measuring crowd density data is to allow a business to advertise when business is slow so that customers will know that they do not have to wait. Yet another object of the system for measuring crowd density data is to allow a business to show the temporal population characteristics of a venue without worrying about the privacy data of their customers. Yet another object of the system for measuring crowd density data is to allow a customer to survey multiple venues for determining their crowdedness. Yet another object of the system for measuring crowd density data is to allow a customer to not worry about their privacy at an establishment. Yet another object of the system for measuring crowd density data is to allow a means for rapidly sorting venues based on crowdedness. An additional object of the system for measuring crowd density data is to allow a business a means for rapidly and cheaply constructing crowdedness camera stations for large events such as concerts.

### DESCRIPTION OF THE FIGURES

FIG. 1 is a diagram view that shows a typical client server system application.

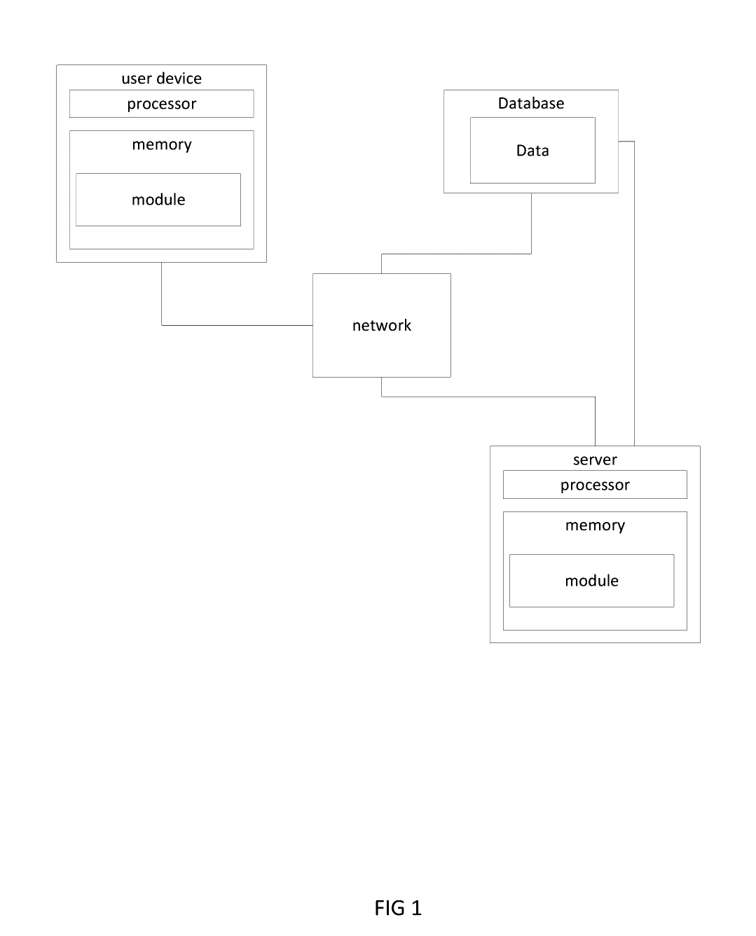

FIG. 2 is a diagram view that exhibits overall use of the system for measuring crowd density data.

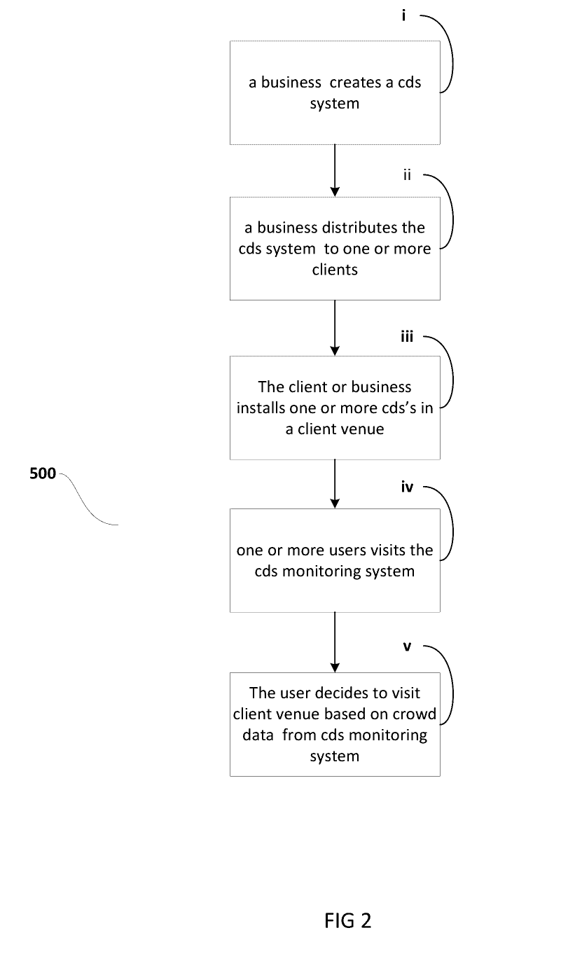

FIG. 3 is a diagram view that exhibits the relationships between modules on the CDS.

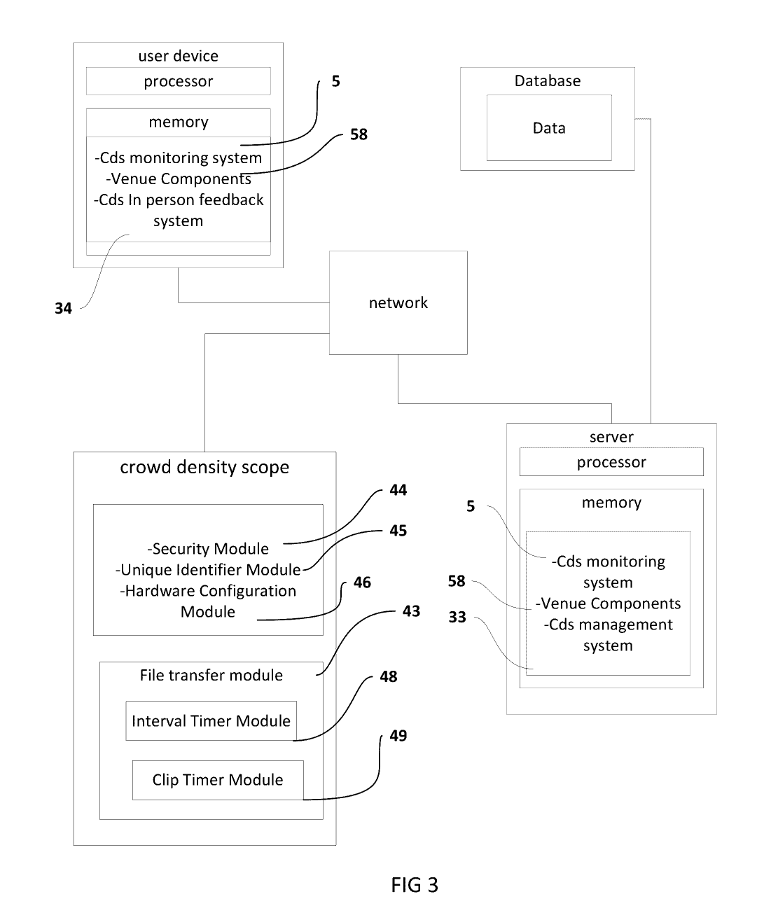

FIG. 4 is a perspective view view that exhibits the CDS outside housing.

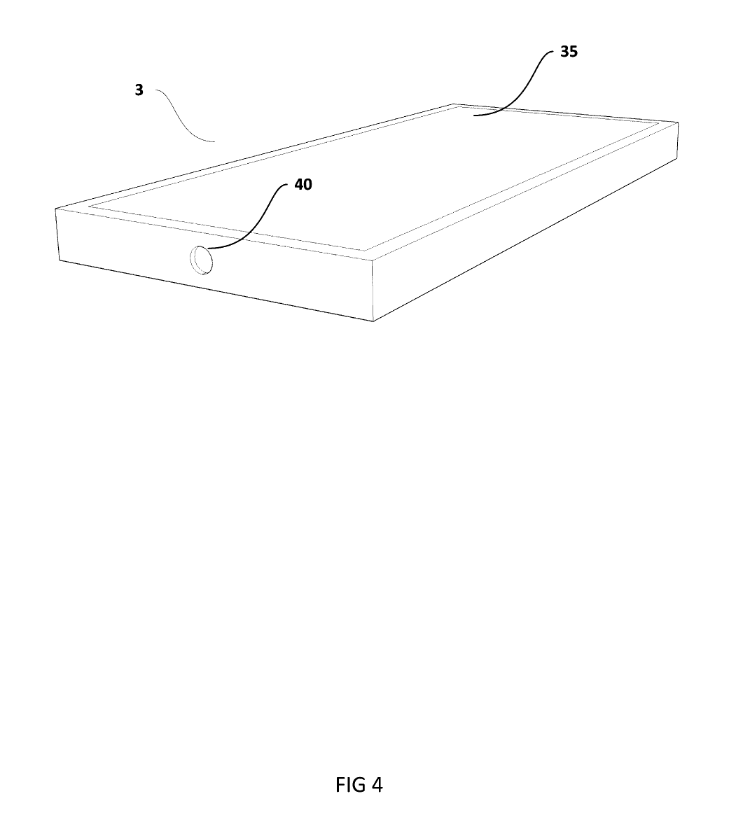

FIG. 5 is a perspective view view that exhibits the CDS components.

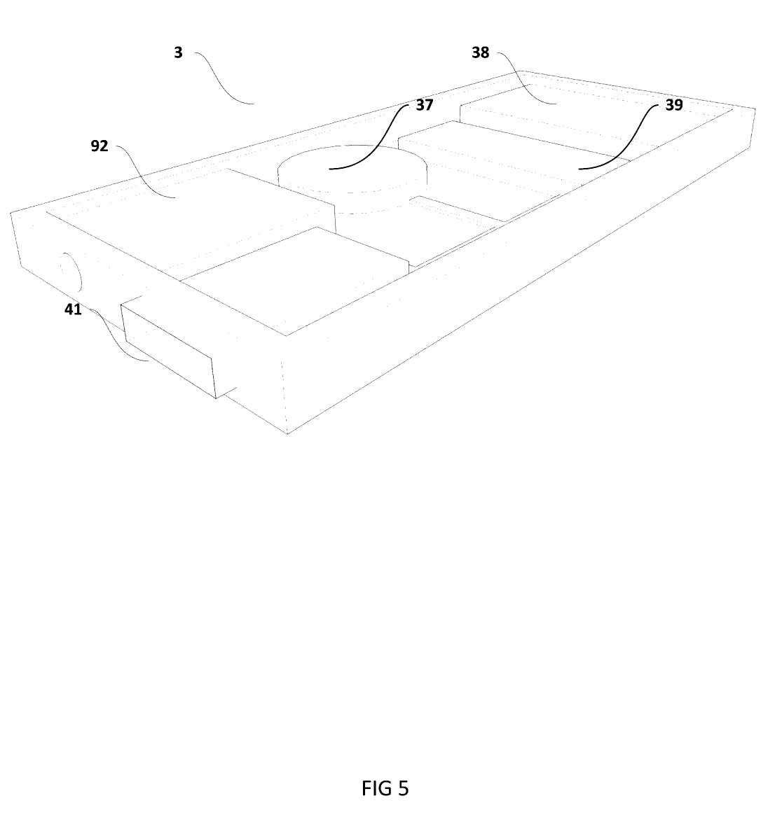

FIG. 6 is a perspective view view that exhibits the CDS within an establishment.

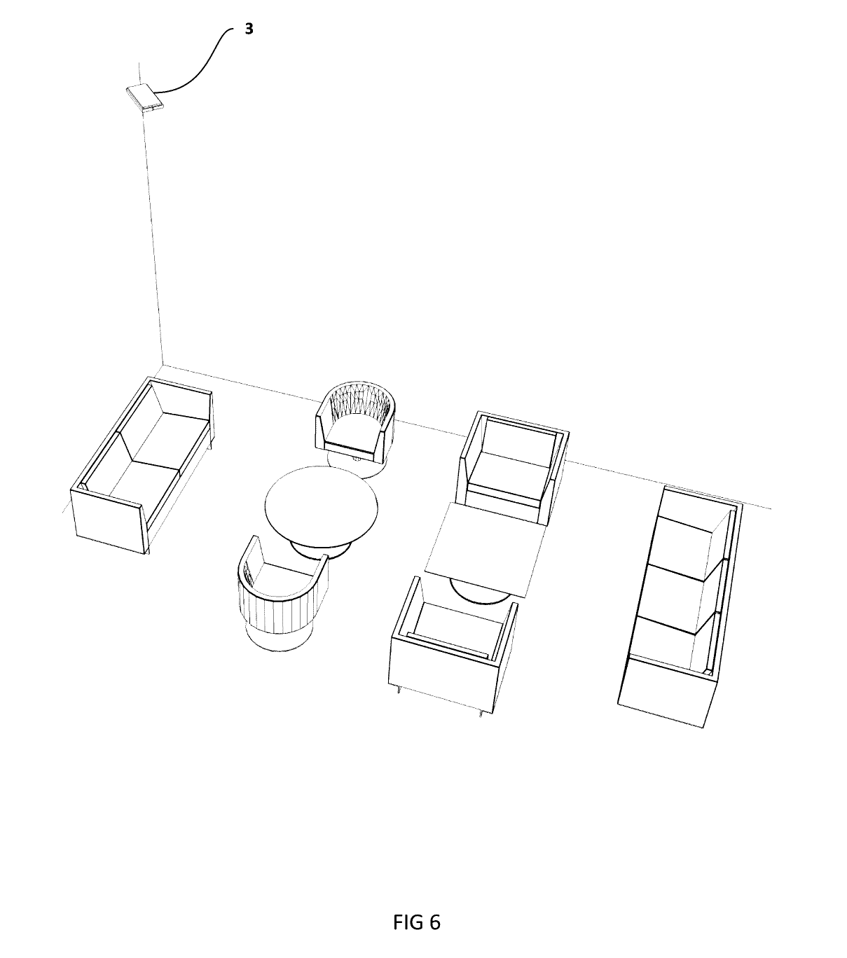

FIG. 7 is a perspective view view that exhibits the CDS at an outdoor venue.

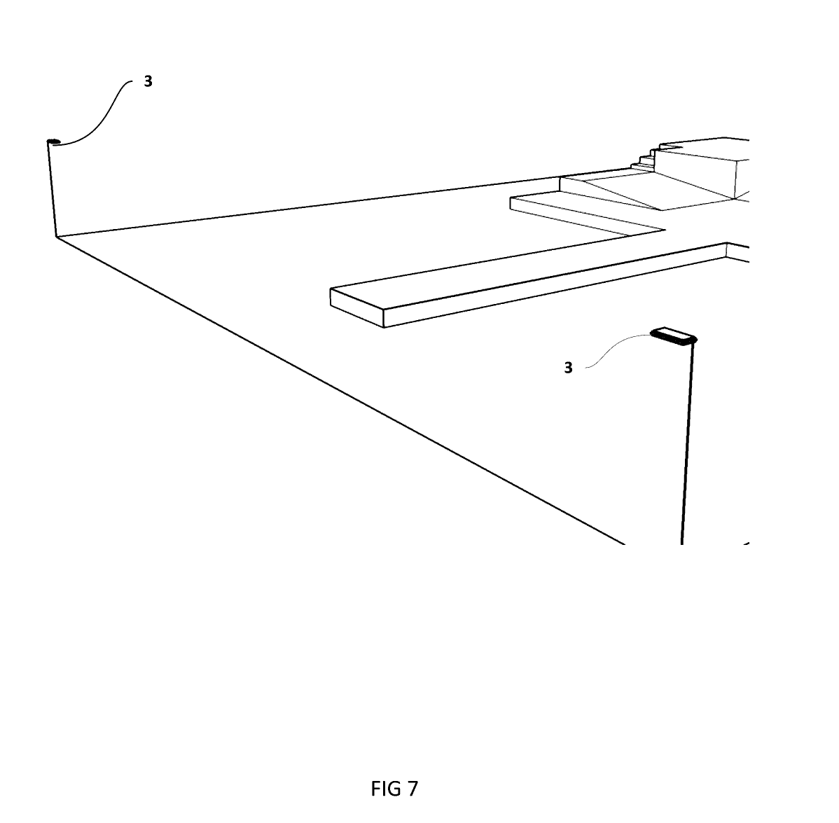

FIG. 8 is an interface view that exhibits evaluation of multiple CDS at one venue.

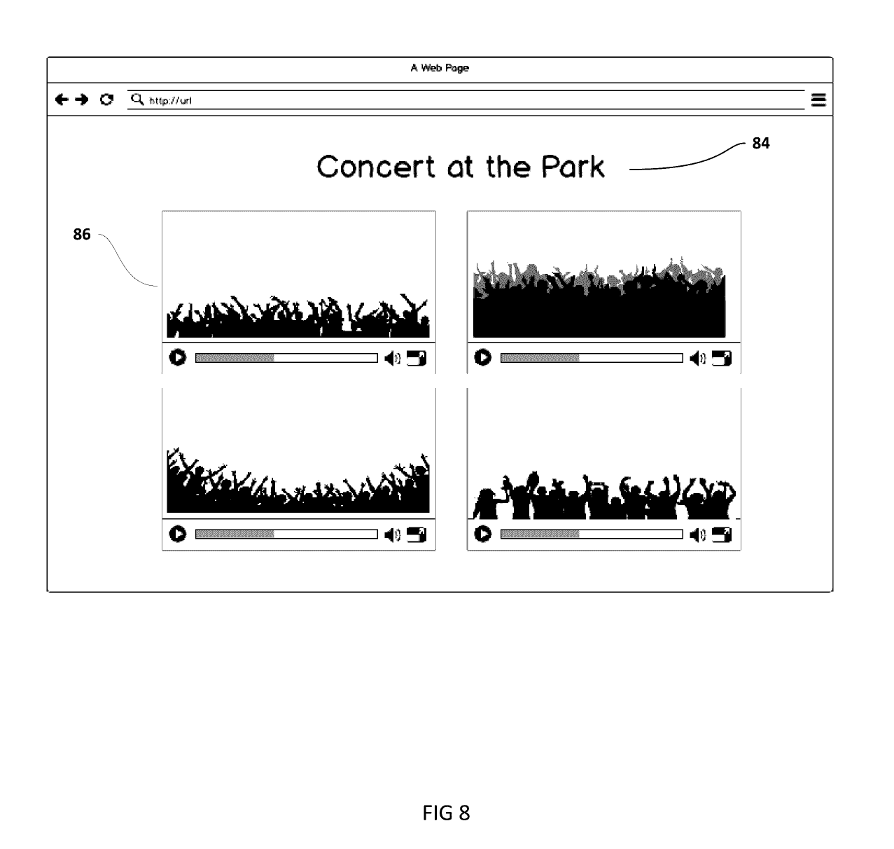

FIG. 9 is an interface view that exhibits evaluation of multiple venues simultaneously.

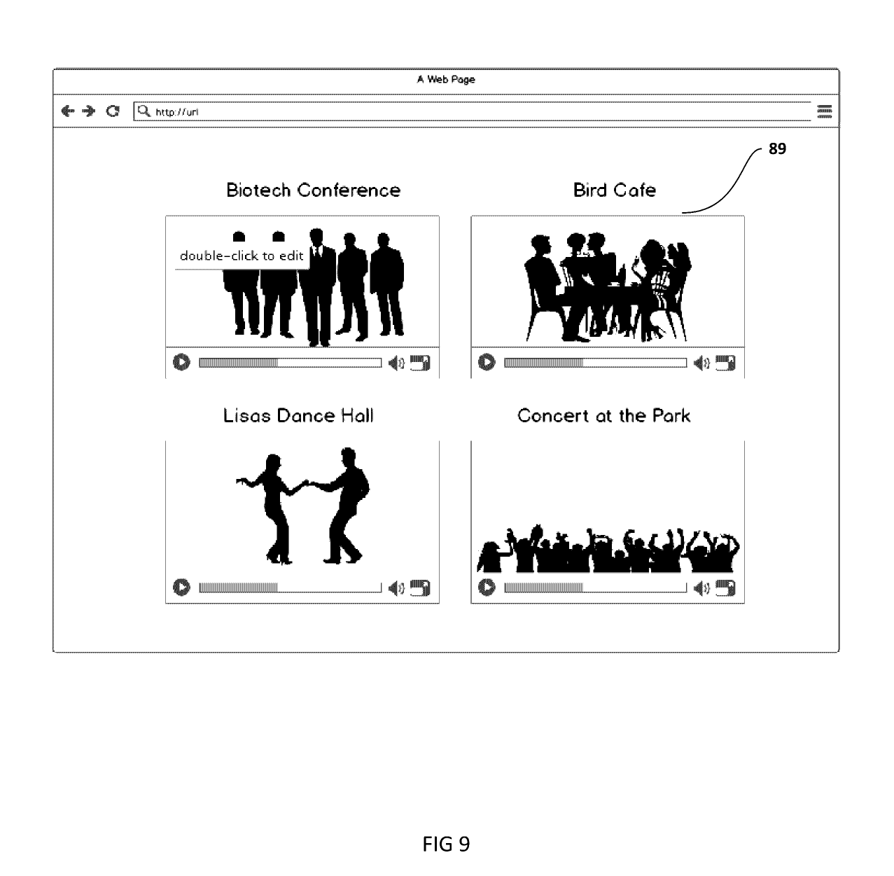

FIG. 10 is an interface view that exhibits evaluation of venues containing CDS.

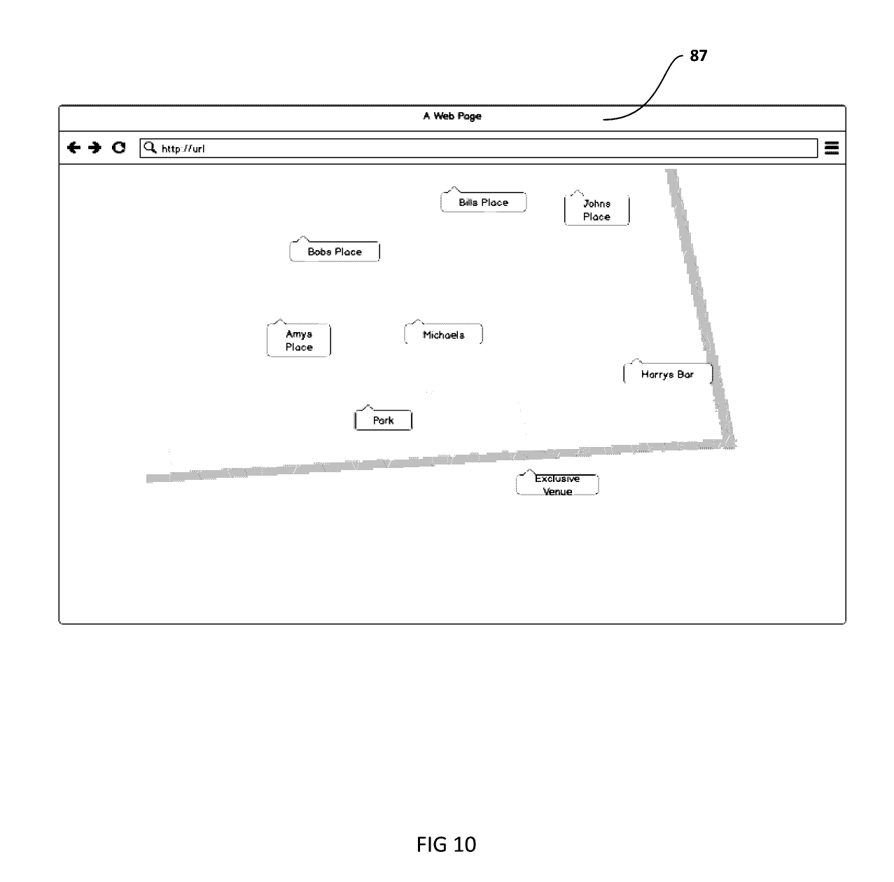

### DETAILED DESCRIPTION OF THE INVENTION

A general method for using the system for measuring crowd density data preferably involve several steps: (i) First, a business a creates crowd density scope (CDS) system 1. (ii) Next, a business distributes the CDS system 1 to one or more clients 2. (iii) Then, a client or business installs one or more CDS 3 in one or more client venue 4. (iv) Then, one or more users visits the CDS monitoring system 5. (v) Finally, one or more users 6 decides to visit one or more client venues 4 based on crowd data 7 from a CDS monitoring system 5. The above method is herein identified as method 500 and while these steps are depicted in an order, it is thought that these steps may be performed in one or more alternative orders and still reflect the novelty of the system for measuring crowd density data.

The system for measuring crowd density data has some elements that are commonly known, however their use and relationships to the novel components and steps of the system for measuring crowd density data render them applicable herein. In order to highlight the roles in the specification, they are subsequently explained here: A mobile device 8 comprises a small computing device, typically small enough to be handheld (and hence also commonly known as a handheld computer 9 or simply handheld) having a display screen with touch input. In some embodiments, one may reason that examples of a mobile device 8 may include mobile computers, mobile internet devices, smartphones, tablet computers, wearable computers, calculator watches, smart watches, a head-mounted display, personal digital assistants, enterprise digital assistants, calculators, handheld game consoles, portable media players, ultra-mobile PCs, digital still cameras, digital video cameras, digital camcorders, mobile phones, smartphone, feature phones, pagers, personal navigation devices and other comparable equivalents.

Wearables 10 is a term that comprises computers that are meant to worn by a user, which may be embedded in clothing or otherwise affixed to a person. In some embodiments, one may reason that examples of an wearables 10 may include a smart watch, a hololens, augmented reality, embedded OLEDS, fiber embedded computers and other comparable equivalents.

A client 2 comprises a proprietor of an event 11 or a business 12 where crowds may gather at a client venue 4. In some embodiments, one may reason that examples of a business 12 may include a bar, a restaurant, a store, a mall and so forth. An event 11 comprises a temporary gathering of people for a specific time period. In some embodiments, one may reason that examples of an event 11 may include a music festival, an education conference, opera houses, amphitheaters, a bandshell, jazz clubs, a public house, nightclubs, stadiums, arenas and so forth.

The term recording duration 13 comprises a duration of a CDS crowd data 14 captured in the form of a video clip 15 or audio clip 16. The video clip 15 comprises a portion of recorded video of one or customer 18 in a client venue 4 that is meant to be evaluated by a user 6. The audio clip 16 comprises a portion of recorded audio of one or customer 18 in a client venue 4 that is meant to be evaluated by a user. The term recording interval 17 comprises a designated time interval of instances between crowd data 7 recordings that area captured by the CDS 3. The term client venue 4 comprises a place where one or more CDS 3 may be, and that has a network connection and is meant for a gathering of people.

A network 19 comprises a telecommunications network that allows computers to exchange data. In some embodiments, one may reason that examples of a network 19 may include a personal area network, a wireless personal area network, a near-me area network, a local area network, a wireless local area network, a wireless mesh network, a wireless metropolitan area network, a wireless wide area network, a cellular network, a home area network, a storage area network, a campus area network, a backbone area network, a metropolitan area network, a wide area network, an enterprise private network, a virtual private network, an intranet, an extranet, a Internetwork, an Internet, a near field communications network, a mobile telephone network and so forth.

A presentation layer 20 comprises graphical output from a module 21 for user interaction typically one or more graphical user interface 22. In some embodiments, one may reason that examples of a presentation layer 20 may include a web browser, an application, a messaging interface and the like. A graphical user interface 22 comprises a type of user interface that allows users to interact with electronic devices through graphical icons and visual indicators such as secondary notation, as opposed to text-based interfaces, typed command labels or text navigation.

A module 21 comprises executable instructions hosted on memory executed by the cpu 23 which perform useful functions for one or more end users. The cpu 23 comprises hardware within a computer that carries out the instructions of a computer program by performing the basic arithmetical, logical, and input/output operations of the system. The program 25 comprises a sequence of instructions, written to perform a specified task with a computer that is executed by the cpu 23. The website 26 comprises a set of related web pages served from one or more web domains. The programming language 27 comprises an artificial language designed to communicate instructions to a machine, particularly a computer. The web browser 28 comprises a software application for retrieving, presenting and traversing information resources on the internet.

A client server model 24 comprises structure in computing that partitions tasks or workloads between the providers of a resource or service, called servers, and service requesters, called clients. A server 31 comprises a system (software and suitable computer hardware) that responds to requests across a computer network and has a cpu 23 capable of executing one or more instructions on one or module 21 present on memory 32. A web page 29 comprises a web document that is suitable for the internet and the web browser. Software 30 comprises a collection of computer programs and related data.

The internet connection means 91 comprises hardware or software used to connect to a network 19. In some embodiments, it is reasonable to contemplate that an example of an internet connection means 91 might include a wi-fi connection or also a hard-wired and the like. Further, a power source 92 comprises local power found at a client venue 4 that is used to power the CDS. In some embodiments, one can contemplate that if an external power source 92 is missing, than the CDS 3 may run off of a battery 37.

Overall, a system for measuring crowd density data is termed a CDS system 1. The CDS system 1 comprises a system that is used to evaluate crowd density via network communication and visual displays. The CDS system 1 preferably comprises a CDS 3, a CDS management system 33, a CDS monitoring system 5, and a CDS in person feedback system 34.

The CDS 3 is a physical object and preferably comprises a housing 35, a mount 36, one or more battery 37, a camera 38, and a micro computer 39. The housing 35 comprises a covering that contains and protects the internal components of an apparatus, device, or electrical system. In the preferred embodiment, the housing 35 is preferably situated around the internal components of the device. In some embodiments, it is thought that examples of a housing 35 may include a casing, a shell, or a sheet and the like. In the preferred embodiment, the mount 36 is preferably situated adjacent to the housing 35 as a means to attach or support a CDS 3 to structure within the client venue 4. In some embodiments, it is thought that examples of amount 36 may include a bracket, a support, a backing, a setting, or a tripod and the like.

Further, the battery 37 is preferably situated within the housing 35, which powers the CDS 3. In some embodiments, it is thought that examples of a battery 37 may include a zinc carbon battery, an alkaline battery, a lithium battery, a nickel cadmium battery, or a nickel zinc battery and the like. In some embodiments, one can contemplate that if the battery 37 is missing, than an external power source may suffice.

The camera 38 comprises a digital video camera which can send and receive data via a computer network and the Internet. Spatially, the camera 38 is preferably arranged within the housing and adjacent to a surface intended to face a crowd. In some embodiments, it is thought that examples of a camera 38 may include a night vision camera, centralized IP cameras, decentralized IP Cameras, webcams, or cctv and the like. The lens 40 of the camera comprises photographic lens or photographic objective that allows one to make images of objects that can be stored storing an electronically. The lens 40 is preferably situated on the camera, outside the housing, and facing a light source. In some embodiments, it is thought that examples of a lens 40 may include a fish eye lens, a swivel lens, or a ccd system and the like.

Further, the micro computer 39 is part of the CDS and comprises a general purpose device that can be programmed to carry out a finite set of arithmetic or logical operations. In the preferred embodiment, the micro computer 39 is preferably situated within the housing 35. The micro computer 39 is designed to both 1) have a means to logically operate the system and to 2) connect camera images to CDS monitoring system 5. In some embodiments, it is thought that examples of a micro computer 39 may include a raspberry pi computer, an arduino chip, a banana pi computer, or a beagle computer and the like. The micro computer 39 preferably comprises a cpu 23, a memory 32 that stores modules and one or more peripheral component 41.

Memory 32 comprises the physical devices used to store programs (sequences of instructions) or data (e.g. program state information) on a temporary or permanent basis for use in a computer or other digital electronic device. In some embodiments, it is thought that examples of memory 32 may include a micro sd card, read-only memory, flash memory, an ferroelectric RAM (F-RAM), holographic memory, optical discs, or non volatile memory and the like.

CDS software 42 is preferably stored on the memory such to have configurable operating instructions for the CDS 3. In turn, CDS software 42 preferably comprises a file transfer module 43, a security module 44, a unique identifier module 45, and a hardware configuration module 46.

A function of the file transfer module 43 is to upload the crowd data 7 from the CDS 3 to the CDS monitoring system 5 via the computer network 47. In some embodiments, it is thought that examples of a file transfer module 43 may include a ftp module, an sftp module, a 9p module, an apple filing protocol (afp) module, an bit torrent module, an infinit module, an ftam module, an ftp module, a ftp over ssl (ftps) module, a hftp module, a hulft module, an http module, an https module, a webdav module, a rcp module, an rsync module, a simple asynchronous file transfer (saft), a secure copy (scp) module, an ssh file transfer protocol (sftp) module, a simple file transfer protocol module, or a t.127 module and the like. A security module 44 comprises one or more software modules having encryption capabailities or otherwise obscures or secures data to prevent unauthorized access to either crowd data 7 and or CDS software 42 components. A unique identifier module 45 comprises a software module having a unique identifier of the CDS 3 to uniquely identify one CDS 3 with a client venue 4 or particular view of a particular client venue.

The hardware configuration module 46 comprises a module or software written instructions that operate the usage characteristics of the CDS 3. In the preferred embodiment, the hardware configuration module 46 preferably comprises an interval timer module 48 (to record a video clip 15 for a clip duration 50 at a recording interval 17), and a clip timer module 49 (to have a means to denote the recording length of a video clip 15), respectively.

One or more peripheral components are situated on the CDS and are designed to both 1) connect data captured from the CDS software 42 to the CDS monitoring system 5 through a computer network 47 and to 2) configure or adapt the CDS software 42 for use. In some embodiments, it is thought that examples of a peripheral component 41 may include an wifi component, a bluetooth component, a WiMax component, a ApIIe Beacon component, a ZigBee radio component, a NFC, an infrared receiver, a usb port, a thunderport, or a ethernet port and the like.

In order to manage the usage of the CDS there is a CDS management system 33. It comprises a series of modules, networked communications, and infrastructure designed to manage the states, events and components of the CDS system used by the manager of the CDS system 1. In some embodiments, it is thought that examples of an CDS management system 33 may include a marketing systems, a CDS inventory systems, user tracking systems, financial systems, and/or sales systems and the like. Further, a CDS management system 33 preferably comprises an additional sub-part herein termed the CDS API 51. which allows an integratation of crowd data gathered by the CDS system 1 with third party apps.

The CDS monitoring system 5 comprises a system interacted with by the end user that allows them to get the benefits of the CDS system 1. These are modules for rapidly evaluating crowd density data from one or more CDS 3 in one one or more client venue 4, and additional modules that allow communication and dissemination of this information with other users, or interested parties. In some embodiments, it is thought that examples of an CDS monitoring system 5 may include a phone app, a web app, a client server application, or desktop software and the like.

The CDS monitoring system 5 may exist on a server memory, client memory, cds memory or removable memory and preferably comprises a bookmarking module 52, a sharing module 53, a register module 54, a login page module 55, a search page module 56, a user components module 57, a venue components module 58, a system components module 59, a commenting components module 60, and a voting components module 61.

The bookmarking module 52 comprises module that performs the function of associating a user 6 with a client venue 4 of interest. The sharing module 53 comprises module that performs the function of indicating that a client venue 4 may be interested to a third party. The register module 54 comprises module that performs the function of allowing a user to sign up for the system. The login page module 55 comprises module that performs the function of allowing a user to log into the system. The search page module 56 comprises module that performs the function of allowing a user to search the system for client venues 62. The user components module 57 comprises module that performs the function of persisting and manipulating typical data properties associated with a user of an application.

In a preferred embodiment, the venue components module 58 may exist on a server memory, client memory, cds memory or removable memory and preferably comprises a venue model 63, and venue views 64, respectively. The venue model 63 comprises a namespaced collection of venue data, that is used to perform similar functions for a user of the system which has venue properties 65. In some embodiments, it is thought that examples of venue properties 65 may include an address property, a phone property, an email property, a url property, a location property, or a hours of operation property and the like.

Other venue properties 65 may be a description property 66 (to store instructions for data related to the description of the property of the of the client venue 4), a venue type property 67 (to store instructions for data related to the type of venue that is the client venue 4), a number of cameras property 68 (to store instructions for data related to the number of CDS 3 within a client venue 4), and a pointer to a CDS components module 69.

A CDS components module 69 preferably comprises one or more modules that comprise the data architecture of the software components such as the CDS model module 70, and the CDS views module 71, respectively. The CDS model module 70 comprises a namespaced collection of storage instructions that allow access, recording, transmission, and storage of information related to use of the CDS 3 and has CDS properties 72 such as a venue id property 73, a room view description property 74, and a crowd data components module 75.

A function of the venue id property 73 is to have storage instructions for data related to uniquely identifying a client venue 4. A function of the room view description property 74 is to have storage instructions for data related to uniquely identifying a room or region at a client venue 4.

In addition, there is a crowd data components module 75 which preferably comprises one or more modules related to the capture and display of information of crowd information from a CDS 3 important to the user. In the preferred embodiment, the crowd data components module 75 preferably comprises a video clip model module 76, and an audio clip model module 77, respectively. A video clip model module 76 is a namespaced collection of storage instructions that allow video recording data from the CDS 3 to be used by an outside user and preferably includes a time information property 78, a CDS id property 79, a length property 80, a start time property 81, and an end time property 82.

A function of the time information property 78 is to have storage instructions for data related to the current of video recording data from the CDS at client venue 4. A function of the CDS id property 79 is to have storage instructions for data related to the unique id of the CDS 3. A function of the length property 80 is to have storage instructions for data related to length of time of recorded video of the CDS 3 before restarting. A function of the start time property 81 is to have storage instructions for data related to the time of of starting recorded video of the cd 83. A function of the end time property 82 is to have storage instructions for data related to the time of the ending of a recorded video of the cds.

The audio clip model module 77 is a namespaced collection of storage instructions that allow audio recording data from the CDS 3 to be used by tan outside user. The audio clip model module 77 preferably comprises properties similar to the video module.

Further, there is a CDS views module 71 which is a graphical user interface that allows one to examine CDS views, for example a client venue view module 84 which a comprises field of view from the camera 38 in a client venue 4. Additional view modules may be a location page 85, or a CDS tile view 86, respectively. The CDS tile view 86 is an interface that allows one to evaluate multiple CDS 3 within a client venue. In some embodiments, one may reason that an example of an CDS tile view 86 may include an CDS list view and the like. Further, system components 59 preferably comprises a venue map view 87, a venue list view 88, and a venue search view 89.

In addition, there is a CDS in person feedback system 34 which comprises a means by which crowd data 7 can be disseminated in another manner besides the CDS 3. For example, by a person who resides at the venue with a phone application module with a check in feature that allows local information to transmitted to a network and displayed to a web browser 28.

It will be appreciated by those skilled in the art that changes could be made to the embodiments described herein without departing from the broad inventive concept thereof. It is understood, therefore, that this system for measuring crowd density data is not limited to the particular embodiments disclosed, but it is intended to cover modifications within the spirit and scope of the present system for measuring crowd density data as defined by the appended claims.

What is claimed is:

1. A crowd density monitor system comprising:
a. A data collection system;
b. A data management system; and,
c. A user interface system.

2. A crowd density monitor system of claim 1 wherein the data collection system comprises:
a. A network system comprising:
b. One or more photographic imaging collection systems;
c. A crowd density management system comprising a crowd density scope;
d. One or more databases; and,

3. A crowd density monitor system of claim 1 wherein the data management system comprises:
a. One or more non-user computer devices.
b. A crowd density file system;
c. One or more databases.

4. A crowd density monitor system of claim 1 wherein the user interface system comprises:
a. One or more user devices.

5. A method of monitoring crowd density comprising:
a. Collecting crowd density data;
b. Optionally, organizing crowd density data;
c. Transferring crowd density data to a server;
d. Optionally, analyzing crowd density data;
e. Transferring crowd density data to a user devise.

6. A method for communicating crowd density data from a local to a user comprising:
a. Collecting crowd density data at a local;
b. Optionally, organizing crowd density data;
c. Transferring crowd density from said local data to a server;
d. Optionally, analyzing crowd density data from said local;
e. Transferring crowd density data from a local to a user devise,
wherein, said crowd density data informs users about the density of crowds at a local.
